(19) United States
(12) Patent Application Publication
(10) Pub. No.: US 2014/0058659 A1
(43) Pub. Date: Feb. 27, 2014

(54) METHOD FOR PROCESSING ELECTRONICALLY STORED CALENDAR DATA IN A COMPUTER-ASSISTED MANNER

(71) Applicant: Bayerische Motoren Werke Aktiengesellschaft, Muenchen (DE)

(72) Inventor: Joachim KOLLING, Eching (DE)

(73) Assignee: Bayerische Motoren Werke Aktiengesellschaft, Muenchen (DE)

(21) Appl. No.: 14/071,097

(22) Filed: Nov. 4, 2013

Related U.S. Application Data
(63) Continuation of application No. PCT/EP2012/057511, filed on Apr. 25, 2012.

(30) Foreign Application Priority Data
May 5, 2011 (DE) 102011075305.2

(51) Int. Cl. G01C 21/00

(52) U.S. Cl. CPC G01C 21/00
USPC 701/410; 701/408; 701/526

(57) ABSTRACT

A method for computer-aided processing of electronically stored calendar data by a user terminal, wherein, by use of the user terminal, a calendar entry is read out of a data memory, the calendar entries including, with respect to an event, at least one piece of information concerning the beginning and the location of the event. The current position and time of the user terminal and a route from the current position of the user terminal to the location of the event, as well as the probable duration for the covering of the route are determined. From the beginning of the event, the current time and the probable duration for the route covering, a time difference is determined which is available up to the start of the route covering, in which case, the time difference is visually and/or audibly outputted for the user.

### CROSS REFERENCE TO RELATED APPLICATIONS

This application is a continuation of PCT International Application No. PCT/EP2012/057511, filed Apr. 25, 2012, which claims priority under 35 U.S.C. §119 from German Patent Application No. DE 10 2011 075 305.2, filed May 5, 2011, the entire disclosures of which are herein expressly incorporated by reference.

### BACKGROUND AND SUMMARY OF THE INVENTION

The invention relates to a method for the computer-aided processing of electronically stored calendar data by use of a user terminal.

User terminals according to the present invention, in particular, are portable computers, such as laptops, notebooks, netbooks, tablet computers, smartphones, PDAs, but also include desktop PCs. The term “user terminal” also applies to man-machine interfaces installed in a motor vehicle. User terminals of the above-mentioned type comprise at least one output device in the form of a display and/or a loudspeaker. Optionally, user terminals used for the invention may also have an input device, particularly for inputting and/or processing data.

Electronic calendar systems are known, for example, as independent software (for example, Outlook® by Microsoft® Company or iCal of Apple® Company. The data of such electronic calendars are usually stored in an internal data memory of the user terminal. As an alternative or in addition, the calendar data may also be stored in a central data memory outside the user terminal. Such central data memories are, as a rule, made available on a central computer, for example, of a firm or a service provider and are managed by the user proper. Furthermore, calendars are also known, where calendar entries can be input and maintained by way of a web browser. The calendar data are stored in a data memory of a service provider, for example, the Google® calendar and can be viewed and managed from any user terminal after an identification and authentication by the user.

As known, the user of a calendar containing calendar entries receives information as to when and where a certain event representing the calendar entry will be taking place. Normally, the user of the user terminal will be informed of the coming event a predefined time before the beginning of an event, for example, by a sound or a message. The length of the time difference at which information concerning the event is to be provided is, as a rule, independently defined by the user or by a person creating the calendar entry.

If the locations of two mutually successive events are situated far apart, the user has to take into account the time required for the location change when planning a calendar entry. The information concerning the approaching event therefore has to be selected by the user in such a manner that the time remaining for reaching the location associated with the calendar entry is sufficiently long. In practice, this has frequently only been achievable by means of some expenditures on the part of the user.

It is an object of the present invention to provide a method and a system which permit a computer-aided processing of electronically stored calendar data.

This object is achieved by a method, and system for performing same, for the computer-aided processing of electronically stored calendar data by way of a user terminal, wherein, by way of the user terminal a calendar entry is read out of a data memory, the calendar entries comprising, with respect to an event, at least one piece of information concerning the beginning and the location of the event. A current position and time of the user terminal are determined. A route from the current position of the user terminal to the location of the event, as well as the probable duration for the covering of the route, are determined. From the beginning of the future event, the current time and the probable duration for the covering of the route, a time difference is determined which is available up to the start of the covering the route. At least the time difference is visually and/or audibly output for the user on an output unit of the user terminal.

The invention provides a method for the computer-aided processing of electronically stored calendar data via a user terminal. User terminals, in particular, are the above-mentioned devices, such as portable and stationary computers, but also infotainment systems with man-machine interfaces in motor vehicles.

In the case of the method, a calendar entry is read out of a data memory by the user terminal, the calendar entries for an event comprising at least one piece of information concerning the beginning and the location of the event. A calendar entry represents an event in which a user can or should participate. In addition to information concerning the beginning and the location of the event, the calendar entry may comprise information concerning the end or the duration of the event. If the beginning and the end are contained in the calendar entry, the time duration can be determined from the entry. Likewise, the information concerning the beginning and the duration of the event will indicate the end of the event. The location of the event may be represented in the form of an address or by geographical longitudinal and latitudinal information. An address usually consists of a street or road, a town or city and, if required, a country. Likewise, the location of the event may be defined indirectly in that, for example, a term pointing to the location is contained in the calendar entry. This may, for example, be the name of a company and the company-internal identification of a building. If there is a relationship between a name and an address, only a name representing the location of the event may be used, as required.

The data memory may optionally be contained in the user terminal. The data memory may also be contained in an external databank which can be reached by way of a wireless or wired communication connection. As required, the storage of the calendar entries can take place in an internal as well as equipment-external data memory, in which case the latter may be inserted into a reading device of the user terminal.

In a further step, the current position and time of the user terminal is determined by the user terminal. The determination of the position and time of the user terminal can take place continuously. If the user terminal is battery-operated, the determination of the position and time of the user terminal can also take place at predefined time intervals in order to save energy. Likewise, it can be provided to couple the determination of the position and the time of the user terminal to the reading of the calendar entry out of the data memory, i.e., the position determination takes place in an automated manner as soon as the calendar entry is/was read out.

In a further step, a route is determined from the current position of the user terminal to the location of the event as well as the probable time duration for covering the route. For this purpose, the information concerning the location is first extracted from the calendar. This is the easiest when the calendar entry comprises a data range reserved for the location. If this is not the case, the extraction will take place by an analysis of the calendar entry.

From the probable duration, a probable arrival time for the arrival at the location of the event can then be determined as a function of the current (actual) time. The determination of the route from the current position of the user terminal to the location of the event is linked according to the invention to the processing of the calendar entry by the user terminal. In this case, the route determination is preferably started in an automated manner by the reading-out and the processing of the calendar entry from the data memory. In particular, the route determination does not have to be started manually by a user of the user terminal.

Furthermore, from the future beginning of the event, the current time and the probable duration for covering the route, the time difference is determined that is available until the start of the covering of the route. At least the time difference is output to an output unit of the user terminal in a manner that is visual and/or real for the user. In addition to the time difference, further information of the calendar entry can optionally be indicated, such as the beginning, the location as well as a description of the event. For this purpose, the output unit may comprise a display and/or a loudspeaker by way of which the above-mentioned information can be outputted.

As a result of the determination of the time difference, which will be available by the time the covering of the route is started, the user of the user terminal will receive, without any effort on his part, a piece of information that simplifies the planning of location-related events. A linking of the information takes place as to where the user terminal is currently located, what the user of the user terminal has planned next, on which route he will reach the event location, how much time is available for that purpose and what he could accomplish or experience along the way.

If all information is stored in the user terminal, the method can be implemented independently by the user terminal. The starting point of the approach is the calendar entry representing an event, which is in the future with respect to a current point in time. In this case, a position determination unit of the user terminal is activated by a calendar entry in order to, starting from a current position of the user terminal, compute a route to the location of the event. By means of the linkage with time information, information can be supplied to the user concerning a timely start of his trip without the necessity that the user has to activate a corresponding planning tool.

In this context, it is preferable for the calendar entry that is next in time with respect to the current time to be read out of the data memory. The reading-out of the calendar entry preferably takes place in an automated manner from the data memory without any active participation of a user of the user terminal.

Calendar entries can be input into the user terminal and/or updated by way of an input device of the user terminal. Likewise, the input and/or the updating can take place by way of another computer, which transmits them in an isochronous or delayed manner into the external data memory or the user terminal.

It is further advantageous for the time difference to be updated in predefined time intervals or time intervals actively defined by the user. As a result, precise planning information can be provided corresponding to the predefined time intervals.

In a further advantageous embodiment, in addition to the time difference and optional information of the pertaining calendar entry, the output unit outputs to the user Points of Interest (POI) situated along the route. The term Points of Interest is known in connection with navigation systems and route planners. POIs are locations that may be of importance to the user of a map or of a navigation system. These may be used for satisfying daily requirements or trip-specific needs, such as gastronomy, accommodations, gas stations, ATM machines or parking garages. They may represent stopping points in urgent situations, such as car repair shops, pharmacies or hospitals, or they point to tourist attractions and leisure offers, among other, movie theaters, sports stadiums, museums and other attractions. POIs may be displayed on a map as small icons. Particularly distinctive points are called landmarks and are used for orientation.

The number of outputted POIs is preferably defined as a function of the determined time difference. As a result, a filtering of all conceivable POIs is to be ensured in order not to overload the user with information. For this purpose, it is also advantageous for the POIs to be categorized with respect to their relevance, in which case, corresponding to the determined time difference, POIs of one or more categories are output. In particular, by indicating preferences, it therefore becomes possible for the user to have only those POIs indicated to him along the route to the location of the next event in which he is actually interested. The filtering therefore relates to favorites of the user of the user terminal. Optionally, the filtering can either take place by the user terminal itself, in that the corresponding filtering information is stored in a data memory of the user terminal. Likewise, this information may be stored in an external data memory. The filtering information can be downloaded and processed, as required, by the user terminal. Likewise, the processing of the POIs and of the filtering information can take place outside the user terminal, the result of the processing then being made available to the user terminal. The external storage of the filtering information will be advantageous particularly when the information of the POIs is also stored outside the user terminal. It is therefore ensured that the POIs are highly updated.

It is further advantageous for the POIs determined for the route to be filtered with respect to relevance corresponding to specifications stored for the user, in which case, only POIs are output that are relevant to the user.

It is further preferred that, in addition to its position, by use of the user terminal, the current geographical orientation is determined and a correct-position map or a correct-position camera image of the user is output into which information is inserted that relates to the route and/or to the points of interest. Optionally, the camera image can also be taken in an up-to-date manner by a camera of the user terminal or can be read out of a data memory. A linking of an electronic calendar takes place with an augmented reality system, in which maps or real video images, by means of a location determination, for example, by means of GPS, and localized information contained in data memories are superimposed. Not only planning information is thereby received, which connects calendar information with augmented reality systems, but also an event-dependent automated operation of the user terminal is achieved with respect to time- and location-related information.

The invention further provides a system for the computer-aided processing of electronically stored calendar data by a user terminal, which is designed for the implementation of the above-described method according to the invention. The user terminal is optionally portable, for example, in the form of a portable computer (laptop, notebook, tablet PC, PDA, Smartphone) or an integral component of a motor vehicle, or retrofitted into the motor vehicle. In the latter case, the system utilizes the output and input devices present in a motor vehicle, such as the display of a navigation system, the push-turn controller for operating the navigation system, etc.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 illustrates an exemplary user terminal for the method according to the invention, in which the user terminal is a cell phone having a display as an output unit.

### DETAILED DESCRIPTION OF THE DRAWING

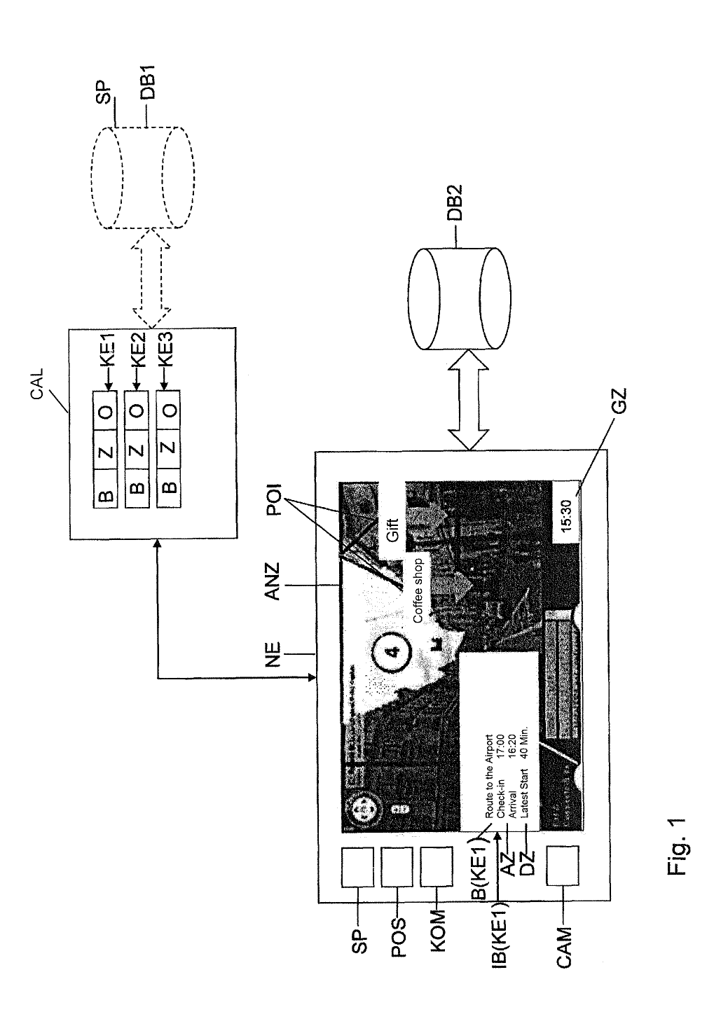

FIG. 1 illustrates a user terminal NE in the form of a cell phone having a display ANZ as the output unit. The user terminal could also be present in a motor vehicle in the form of a portable computer, a desktop PC or in a fixed installed fashion. In particular, the user terminal NE may be present in the form of the devices described in the introduction to the specification.

The display ANZ may be constructed as a touch screen, so that a data input can also take place by way of the display. Since the technical method of operation of touch screens is sufficiently known to a person familiar with the state of the art, this method will not be described here in detail. If the display ANZ is not constructed as a touch screen, the user terminal could have a separate keyboard as the input device. Other forms of input devices, such as a pen input, are also contemplated.

The user terminal NE further has a data memory SP which can be accessed by a computer unit (microprocessor) which is known per se and not shown. The data memory SP is used for the permanent and/or temporary storage of program applications as well as of user data. In this context, user data are data generated by the user of the user terminal NE or produced during the implementation of a program application. For example, user data may be the calendar data relevant to the application. In principle, device-related data and user data may also be processed in different data memories. Likewise, a jointly used memory, which is virtually divided into different storage areas, can be provided. The data memory SP could, at least partially, also be formed by a data memory temporarily inserted into the user terminal NE. Such memories are available, for example, in the form of card-shaped data carriers. These may be of the Micro Secure Digital (Micro SD), Compact Flash, Micro Drive, Memory Stick, Secure Digital Card, Multimedia Card, xD Picture Card, Smart Media Card type, etc.

The user terminal NE further includes devices for position detection. A position detection unit POS may be designed, for example, as a GPS (Global Positioning System) receiver. Furthermore, the user terminal NE includes a compass (KOM) for determining the orientation of the user terminal. As a result of the information supplied by the compass, a camera picture or a map of the environment of the user terminal can be illustrated in the correct position with respect to the position detected by the position detection unit POS. By means of the camera CAM integrated in the user terminal NE, a picture can be taken of the environment and can be displayed on the display unit ANZ.

To this extent, the described user terminal corresponds to conventional commercially available devices.

The user of the user terminal NE is in possession of an electronic calendar CAL. A number of calendar entries KE1, KE2, KE3 are contained in the calendar CAL. Each of the calendar entries KE1, KE2, KE3 is assigned to an event and includes a piece of information with respect to the event concerning the beginning B, the time duration Z (or alternatively, the end) of the event, as well as the location O at which the event takes place.

As examples, only three calendar entries KE1, KE2, KE3 are shown in the only schematically illustrated calendar CAL. It is understood that the calendar CAL may have a much larger or different number of calendar entries for one day or a plurality of days.

The calendar CAL may be contained either in a data memory SP of an external databank DB1 or in the data memory SP of the user terminal NE. Likewise, the calendar CAL may be simultaneously stored in both data memories SP. Should the calendar CAL only be stored in the databank DB1, it would be advantageous for the purpose of a permanent access to the calendar entries KE1 for a wireless or wired communication connection to exist between the user terminal NE and the databank DB1.

FIG. 1 illustrates a further databank DB2 which can be accessed by the user terminal NE in a wireless or wired manner. The databank DB2 contains map data and/or points of interest (POI), for example, for a certain geographical area. Furthermore, user-related data can be stored in the databank DB2, which contain, for example, preferences for the POIs. The POIs may be present in a categorized form, so that, for example, the POIs most interesting to the user are contained in Category 1, the next-interesting POIs are contained in Category 2, etc. As an alternative, the information contained in the databank DB2 may also be contained in the data memory SP of the user terminal NE.

For implementing the method according to the invention for the computer-aided processing of the calendar entries contained in the calendar CAL, the calendar entry (here: KE1) that is next in time with respect to the current time GZ (here: 15:30) is read out in an automated manner, i.e., without active participation by the user of the user terminal NE. The current time GZ, which is displayed to the user in an optionally permanent manner in the display ANZ of the user terminal NE, may, for example, be taken from an internal clock of the user terminal. As a result of the calendar entry KE1, the user terminal has information as to where and when the user of the user terminal NE wants to be aware of a next event/next appointment.

By use of its integrated position detection unit POS, the user terminal NE—initiated by the reading-out of the calendar entry KE1—first determines the current position as well as the current time GZ. Subsequently, a route is determined from the current position to the location O of the calendar entry KE1. In a conventional manner, the probable duration is determined for the covering of the route. By use of the current time GZ and the probable duration for the covering of the route, a probable arrival time AZ can be determined in this case. Furthermore, the method makes it possible to determine a time difference DZ from the beginning B of the event KE1, the current time GZ and the probable duration (here: 50 minutes; determined from the difference between the arrival time AS (16:20)) and the current time GZ (15:30)) for the covering of the route. The time difference DZ is obtained from the beginning B of the event KE1 and of the arrival time AZ estimated to the current point in time (here: 40 minutes). This time difference DZ is available to the user of the user terminal at the current point in time GZ to the start of the covering of the route, so that the user will not miss the beginning of the event assigned to the calendar entry KE1. At least the time difference, preferably also the beginning B of the event KE1, as well as the determined arrival time AZ, are indicated to the user on the display ANZ in an information area IB. In this case, the information area IB comprises only information relevant to the calendar entry KE1, symbolized by IB(KE1).

Simultaneously, in the present embodiment, a correctly positioned picture is shown on the display ANZ by the camera while utilizing the cardinal direction determined by the compass. In principle, the image could also be read out of a databank, which is possible, for example, by using Google Preview. Corresponding to the approach known from augmented reality systems, user-relevant points of interest (POI) are inserted into the image. For example, two POIs are shown (a “coffee shop” and “gift” shop)—optionally filtered by means of user preferences.

As an alternative, a map could be shown on the display which illustrates the route (partially or completely) from the current location to location O of the calendar entry KE1. The points of interests which are of interest to the user could be shown, for example, as pins along the route.

In a further embodiment, in addition to the calendar entry KE1 next in time, subsequent calendar entries KE2, KE3 could also be illustrated in an abbreviated form in the display.

As soon as the calendar entry KE1 is in the past, the next calendar entry KE2 is read out of the data memory in an automated manner, i.e., again without any active participation by the user of the user terminal NE, and the location assigned to the calendar entry KE2 as well as a route thereto are found. The above-described approach will be repeated in this case.

The approach according to the invention provides a bringing-together of electronic calendar data with localized information concerning locations that are of interest to a user. In this case, the bringing-together of the information takes place in an automated manner without any participation by the user. The method according to the invention can be implemented in the form of an application which runs permanently on the user terminal or first has to be started by the user of the user terminal. The application can be used particularly for commercial services where a fee has to be paid, for example, for the POIs inserted along a computed route per advertisement or also based on more detailed information.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for computer-aided processing of electronically stored calendar data by a user terminal, the method comprising the acts of:
reading out of a data memory, via the user terminal, a calendar entry, wherein the calendar entry comprises, with respect to an event, at least one piece of information concerning a beginning and a location of the event;
determining a current position of the user terminal and a current time at the user terminal;
determining a route from the current position of the user terminal to the location of the event and determining a probable duration for covering the route from the current position of the user terminal to the location of the event;
based on the beginning of the event, the current time and the probable duration for covering of the route, determining a time difference available between the current time and a route start time for covering the route; and
outputting, on an output unit of the user terminal, the determined time difference in a visually and/or audible manner for a user of the user terminal.

2. The method according to claim 1, wherein the calendar entry that is next in time with respect to the current time is read out of the data memory.

3. The method according to claim 2, wherein the reading of the calendar entry out of the data memory takes place in an automated manner without any active participation of the user of the user terminal.

4. The method according to claim 1, wherein the reading of the calendar entry out of the data memory takes place in an automated manner without any active participation of the user of the user terminal.

5. The method according to claim 1, wherein the time difference is updated at predefined time intervals or time intervals actively defined by the user.

6. The method according to claim 1, wherein, in addition to the time difference and optional information of the pertaining calendar entry, points of interest situated along the route are outputted to the user by way of the output unit.

7. The method according to claim 6, wherein a number of outputted points of interest is defined as a function of the determined time difference.

8. The method according to claim 7, wherein the points of interest are categorized with respect to relevance, and further wherein points of interest of one or more predefined categories are output corresponding to the determined time difference.

9. The method according to claim 6, wherein the points of interest are categorized with respect to relevance, and further wherein points of interest of one or more predefined categories are output corresponding to the determined time difference.

10. The method according to claim 6, wherein the points of interest determined for the route are filtered with respect to relevance corresponding to specifications stored for the user, only points of interest relevant to the user being output.

11. The method according to claim 7, wherein the points of interest determined for the route are filtered with respect to relevance corresponding to specifications stored for the user, only points of interest relevant to the user being output.

12. The method according to claim 8, wherein the points of interest determined for the route are filtered with respect to relevance corresponding to specifications stored for the user, only points of interest relevant to the user being output.

13. The method according to claim 1, further comprising the acts of:
in addition to the current position, determining, via the user terminal, a current geographical orientation; and
outputting a map correctly positioned for the user or a camera picture, wherein route and/or information concerning points of interest are inserted into the outputted map or camera picture.

14. The method according to claim 13, wherein the camera picture is taken in an up-to-date manner by a camera of the user terminal or is read out of a data memory.

15. A system for computer-aided processing of electronically stored calendar data, the system comprising:
a user terminal comprising a microprocessor and a computer readable medium, wherein the computer readable medium has stored thereon program code segments that:
reads out of a data memory, via the user terminal, a calendar entry, wherein the calendar entry comprises, with respect to an event, at least one piece of information concerning a beginning and a location of the event;
determines a current position of the user terminal and a current time at the user terminal;
determines a route from the current position of the user terminal to the location of the event and determines a probable duration for covering the route from the current position of the using terminal to the location of the event;
based on the beginning of the event, the current time and the probable duration for the covering of the route, determines a time difference available between the current time and a route start time for covering the route; and
outputs, on an output unit of the user terminal, the determined time difference in a visually and/or audible manner for a user of the user terminal.

16. The system according to claim 15, wherein the user terminal is a portable user terminal.

17. The system according to claim 15, wherein the user terminal is an electronic component integrated into a motor vehicle.
